(19) United States
(12) Patent Application Publication
(10) Pub. No.: US 2011/0091035 A1
(43) Pub. Date: Apr. 21, 2011

(54) HARDWARE KASUMI CYPHER WITH HYBRID SOFTWARE INTERFACE

(75) Inventors: Lawrence Spracklen, Boulder Creek, CA (US); Farnad Sajjadian, Sunnyvale, CA (US); Christopher H. Olson, Austin, TX (US); Sanjay Patel, Fremont, CA (US)

(73) Assignee: SUN MICROSYSTEMS, INC., Santa Clara, CA (US)

(21) Appl. No.: 12/582,299

(22) Filed: Oct. 20, 2009

(51) Int. Cl. H04L 9/18

(52) U.S. Cl. 380/37; 380/44

(57) ABSTRACT

A system including a memory; a software interface, operatively connected to the memory, and configured to generate a modified version of a confidentially key (CKey), and a modified version of an integrity key (IKey); and a Kasumi engine having a hardware implementation of a Kasumi cipher and configured to load the modified version of the CKey from the memory to perform a confidentiality function, and to load the modified version of the IKey from memory to perform an integrity function.

### BACKGROUND

In cryptology, confidentiality is defined by the International Organization for Standardization (ISO) in ISO-1779 as “ensuring that information is accessible only to those authorized to have access” and is one of the cornerstones of information security. Confidentiality is one of the design goals for many cryptosystems, made possible in practice by the techniques of modern cryptography.

In computer science and telecommunications, integrity is a term that can mean ensuring data is “whole” or complete, the condition in which data is identically maintained during any operation (such as transfer, storage or retrieval), the preservation of data for their intended use, or, relative to specified operations, the a priori expectation of data quality. In other words, data integrity is the assurance that data is consistent and correct. Often such integrity is ensured by use of a number referred to as a message authentication code (MAC).

The 3rd Generation Partnership Project (3GPP) is a collaboration between groups of telecommunications associations, to make a globally applicable third generation (3G) mobile phone system specification within the scope of the International Mobile Telecommunications-2000 project of the International Telecommunication Union (ITU). 3GPP specifications are based on evolved Global System for Mobile Communications (GSM) specifications. 3GPP standardization encompasses Radio, Core Network and Service architecture. The 3GPP standardization sets forth both a confidentiality algorithm and an integrity algorithm.

### SUMMARY

A method of performing a confidentiality function for a plurality of input bits. The method comprising: generating, using a software interface having access to a memory, an initialization value and a modified version of a confidentiality key (CKey); loading, from the memory, the initialization value and the modified version of the CKey into a Kasumi engine having a hardware implementation of a Kasumi cipher; executing, using the Kasumi cipher and based on the modified version of the CKey, an initial Kasumi operation on the initialization value to generate an intermediate output; partitioning, using the software interface, the plurality of input bits into a plurality of input blocks and storing a cardinality of the plurality of input blocks in the memory; loading, from the memory, the CKey and the cardinality into the Kasumi engine; generating, using the Kasumi cipher and based on the cardinality and the CKey, a plurality of keystream blocks by executing a plurality of Kasumi operations on the intermediate output; and generating a plurality of output bits by performing a plurality of exclusive-or (XOR) operations between the plurality of input blocks and the plurality of keystream blocks.

A method of performing an integrity function for a plurality of input bits. The method comprising: generating, using a software interface operatively connected to a memory, a padded string having a plurality of blocks by concatenating a random number and the plurality of input bits; loading, from the memory, the padded string and an integrity key (IKey) into a Kasumi engine having a hardware implementation of a Kasumi cipher; generating, using the Kasumi cipher and based on the IKey, a plurality of intermediate values by executing a plurality of initial Kasumi operations on the plurality of blocks; performing a plurality of exclusive-or (XOR) operations between the plurality of intermediate values to generate an intermediate output; generating, using the software interface, a modified version of the IKey; loading, from the memory, the modified version of the IKey into the Kasumi engine; and generating, using the Kasumi cipher and based on the modified version of the IKey, a message authentication code (MAC) by executing a Kasumi operation on the intermediate output.

A system, comprising: a memory; a software interface, operatively connected to the memory, and configured to generate a modified version of a confidentially key (CKey), and a modified version of an integrity key (IKey); and a Kasumi engine having a hardware implementation of a Kasumi cipher and configured to load the modified version of the CKey from the memory to perform a confidentiality function, and to load the modified version of the IKey from memory to perform an integrity function.

Other aspects of the invention will be apparent from the following description and the appended claims.

### BRIEF DESCRIPTION OF DRAWINGS

FIG. 1 shows a multithreading processor in accordance with one or more embodiments of the invention.

FIG. 2 shows a system in accordance with one or more embodiments of the invention.

FIG. 3 shows a flowchart in accordance with one or more embodiments of the invention.

FIG. 4 shows a flowchart in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method of performing confidentiality and integrity functions using a hardware Kasumi cipher with a software interface. Specifically, the hardware Kasumi cipher is configured to execute the one or more Kasumi operations required by the confidentiality and integrity functions, while the software interface is configured to generate/obtain one or more values required by the Kasumi operations. The confidentiality and integrity functions may be used as part of a 3GPP mobile communications system.

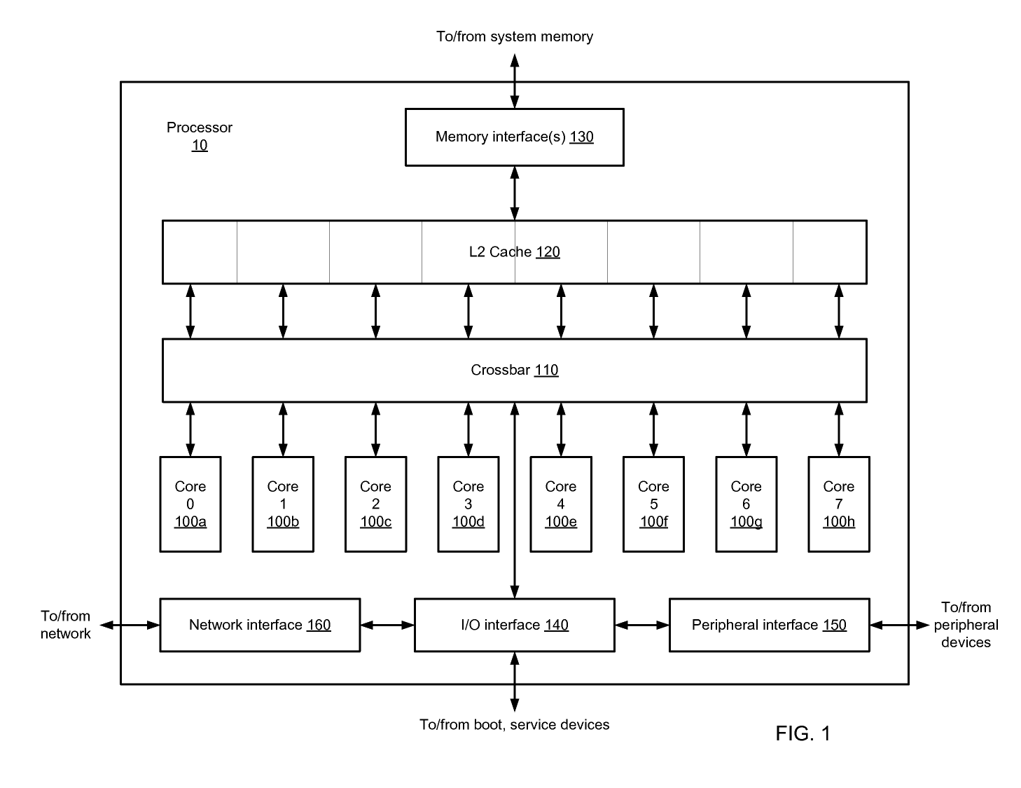

FIG. 1 shows a multithreading processor (10) in accordance with one or more embodiments of the invention. As shown in FIG. 1, processor (10) includes a plurality of processor cores (100a-h), which are also designated “core 0” though “core 7”. Each of cores (100) is coupled to an L2 cache (120) via a crossbar (110). L2 cache (120) is coupled to one or more memory interface(s) (130), which are coupled in turn to one or more banks of system memory (not shown). Additionally, crossbar (110) couples cores (100) to input/output (I/O) interface (140), which is in turn coupled to a peripheral interface (150) and a network interface (160). As described in greater detail below, I/O interface (140), peripheral interface (150) and network interface (160) may respectively couple processor (10) to boot and/or service devices, peripheral devices, and a network.

Cores (100) may be configured to execute instructions and to process data according to a particular instruction set architecture (ISA). In one embodiment, cores (100) may be configured to implement the SPARC® V9 ISA, although in other embodiments it is contemplated that any desired ISA may be employed, such as x86, PowerPC® or MIPS , for example. In the illustrated embodiment, each of cores (100) may be configured to operate independently of the others, such that all cores (100) may execute in parallel. Additionally, each of cores (100) may be configured to execute multiple threads concurrently, where a given thread may include a set of instructions that may execute independently of instructions from another thread. For example, an individual software process, such as an application, may consist of one or more threads that may be scheduled for execution by an operating system. Such a core (100) may also be referred to as a multithreaded (MT) core. In one embodiment, each of cores (100) may be configured to concurrently execute instructions from eight threads, for a total of 64 threads concurrently executing across processor (10). However, in other embodiments it is contemplated that other numbers of cores (100) may be provided, and that cores (100) may concurrently process different numbers of threads.

Crossbar (110) may be configured to manage data flow between cores (100) and the shared L2 cache (120). In one embodiment, crossbar (110) may include logic (such as multiplexers or a switch fabric, for example) that allows any core (100) to access any bank of L2 cache (120), and that conversely allows data to be returned from any L2 bank to any core (100). Crossbar (110) may be configured to concurrently process data requests from cores (100) to L2 cache (120) as well as data responses from L2 cache (120) to cores (100). In some embodiments, crossbar (110) may include logic to queue data requests and/or responses, such that requests and responses may not block other activity while waiting for service. Additionally, in one embodiment crossbar (110) may be configured to arbitrate conflicts that may occur when multiple cores (100) attempt to access a single bank of L2 cache (120) or vice versa.

L2 cache (120) may be configured to cache instructions and data for use by cores (100). In the illustrated embodiment, L2 cache (120) may be organized into eight separately addressable banks that may each be independently accessed, such that in the absence of conflicts, each bank may concurrently return data to a respective core (100). In some embodiments, each individual bank may be implemented using set-associative or direct-mapped techniques. For example, in one embodiment, L2 cache (120) may be a 4 megabyte (MB) cache, where each 512 kilobyte (KB) bank is 16-way set associative with a 64-byte line size, although other cache sizes and geometries are possible and contemplated. L2 cache (120) may be implemented in some embodiments as a writeback cache in which written (dirty) data may not be written to system memory until a corresponding cache line is evicted.

In some embodiments, L2 cache (120) may implement queues for requests arriving from and results to be sent to crossbar (110). Additionally, in some embodiments L2 cache (120) may implement a fill buffer configured to store fill data arriving from memory interface (130), a writeback buffer configured to store dirty evicted data to be written to memory, and/or a miss buffer configured to store L2 cache accesses that cannot be processed as simple cache hits (e.g., L2 cache misses, cache accesses matching older misses, accesses such as atomic operations that may require multiple cache accesses, etc.). L2 cache (120) may variously be implemented as single-ported or multiported (i.e., capable of processing multiple concurrent read and/or write accesses). In either case, L2 cache (120) may implement arbitration logic to prioritize cache access among various cache read and write requestors.

Memory interface (130) may be configured to manage the transfer of data between L2 cache (120) and system memory, for example in response to L2 fill requests and data evictions. In some embodiments, multiple instances of memory interface (130) may be implemented, with each instance configured to control a respective bank of system memory. Memory interface (130) may be configured to interface to any suitable type of system memory, such as Fully Buffered Dual Inline Memory Module (FB-DIMM), Double Data Rate or Double Data Rate 2 Synchronous Dynamic Random Access Memory (DDR/DDR2 SDRAM), or Rambus® DRAM (RDRAM®), for example. In some embodiments, memory interface (130) may be configured to support interfacing to multiple different types of system memory.

Still referring to FIG. 1, processor (10) may also be configured to receive data from sources other than system memory. I/O interface (140) may be configured to provide a central interface for such sources to exchange data with cores (100) and/or L2 cache (120) via crossbar (110). In some embodiments, I/O interface (140) may be configured to coordinate Direct Memory Access (DMA) transfers of data between network interface (160) or peripheral interface (150) and system memory via memory interface (130). In addition to coordinating access between crossbar (110) and other interface logic, in one embodiment I/O interface (140) may be configured to couple processor (10) to external boot and/or service devices. For example, initialization and startup of processor (10) may be controlled by an external device (e.g., a Field Programmable Gate Array (FPGA)) that may be configured to provide an implementation- or system-specific sequence of boot instructions and data. Such a boot sequence may, for example, coordinate reset testing, initialization of peripheral devices and initial execution of processor (10), before the boot process proceeds to load data from a disk or network device. Additionally, in some embodiments such an external device may be configured to place processor (10) in a debug, diagnostic, or other type of service mode upon request.

Peripheral interface (150) may be configured to coordinate data transfer between processor (10) and one or more peripheral devices. Such peripheral devices may include, without limitation, storage devices (e.g., magnetic or optical media-based storage devices including hard drives, tape drives, CD drives, DVD drives, etc.), display devices (e.g., graphics subsystems), multimedia devices (e.g., audio processing subsystems), or any other suitable type of peripheral device. In one embodiment, peripheral interface (150) may implement one or more instances of an interface such as Peripheral Component Interface Express (PCI Express™) although it is contemplated that any suitable interface standard or combination of standards may be employed. For example, in some embodiments peripheral interface (150) may be configured to implement a version of Universal Serial Bus (USB) protocol or IEEE 1394 (Firewire®) protocol in addition to or instead of PCI Express™.

Network interface (160) may be configured to coordinate data transfer between processor (10) and one or more devices (e.g., other computer systems) coupled to processor (10) via a network. In one embodiment, network interface (160) may be configured to perform the data processing necessary to implement an Ethernet (IEEE 802.3) networking standard such as Gigabit Ethernet or 10-Gigabit Ethemet, for example, although it is contemplated that any suitable networking standard may be implemented. In some embodiments, network interface (160) may be configured to implement multiple discrete network interface ports.

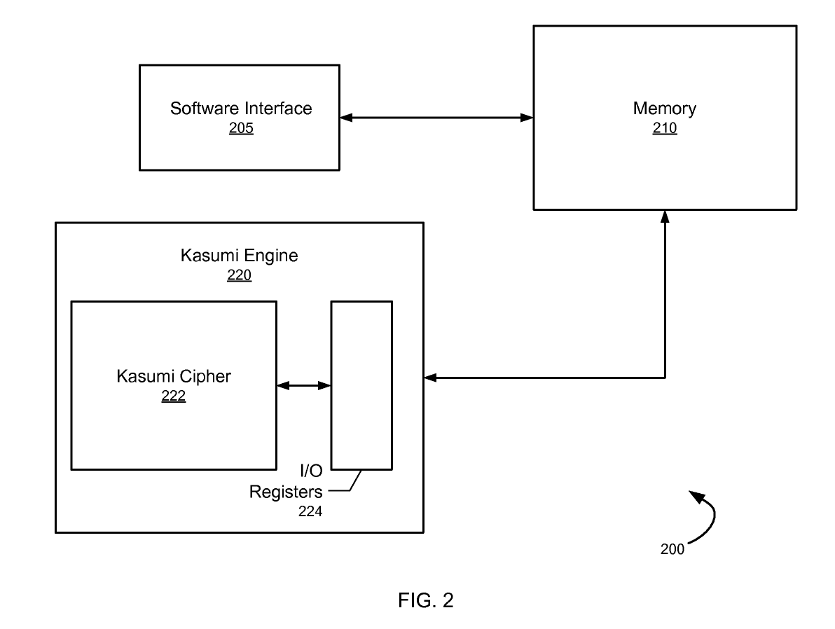

FIG. 2 shows a system (200) in accordance with one or more embodiments of the invention. As shown in FIG. 2, the system (200) has multiple components including a software interface (205), a memory (210), and a Kasumi engine (220). One or more components of the system (200) may be part of a multithreading processor (e.g., processor (10) discussed above in reference to FIG. 1). Further, the components of the system (200) are described below and may be located on the same device (e.g., a server, a mainframe, a desktop PC, a laptop, a PDA, a television, a cable box, a satellite box, a kiosk, a telephone, a mobile phone, a base station of a mobile cellular system, etc.) or may be located on separate devices connected by a network (e.g., the Internet), with wired and/or wireless segments.

In one or more embodiments of the invention, the memory (210) is accessible to both the software interface (205) and the Kasumi engine (220). The memory (210) may be of any size and may be implemented using any combination of memory types (e.g., dynamic random access memory (DRAM), static random access memory (SRAM), zero capacitor random access memory (ZRAM), twin transistor random access memory (TTRAM), flash memory, etc.).

In one or more embodiments of the invention, the Kasumi engine (220) includes one or more hardware implemented Kasumi ciphers (i.e., Kasumi Cipher (222)) operatively connected to one or more input/output (I/O) registers (224). The Kasumi cipher (222) is a block cipher having a block size of 64-bits and a key size of 128-bits. In other words, the Kasumi cipher (222) accepts an input value that is 64-bits in size and transforms the input value into an output value that is also 64-bits in size. Further, the exact transformation of the input value is based on the 128-bit key, which is also provided as input to the Kasumi cipher (222). Those skilled in the art, having the benefit of this detailed description, will appreciate that the Kasumi cipher (222) is a Feistel cipher with eight rounds. In one or more embodiments of the invention, the Kasumi cipher (222) may operate in a chained mode in which the output of one Kasumi operation is used as an input to a subsequent Kasumi operation.

In one or more embodiments of the invention, the I/O registers (224) load values from the memory (210) for use as inputs to the Kasumi cipher (222) (e.g., confidentiality keys, integrity keys, padded strings, initialization values, input bit streams, etc.) (discussed below). In addition, the I/O registers (224) store values generated by the Kasumi cipher (222) for storage in the memory (210). In one or more embodiments of the invention, the Kasumi Engine (220) includes logic (not shown) for performing mathematical operations on one or more of the I/O registers (224) including bitwise operations (e.g., AND operations, OR operations, XOR operations, NOT operations, etc.) and comparison operations (i.e., greater than, less than, equal, not equal, etc.).

In one or more embodiments of the invention, the software interface (205) comprises one or more software applications for generating and/or obtaining values for storage in the memory (210) and later use by the Kasumi engine (220). The software interface (205) may accept input from users (not shown), other software applications (not shown), and/or other hardware components (not shown) in order to generate/obtain said values.

In one or more embodiments of the invention, the system (200) of FIG. 2 may be used to implement the f8 confidentiality algorithm of 3GPP mobile communications. Specifically, the Kasumi engine (220) may be used to perform the one or more Kasumi operations and XOR operations required by the f8 confidentiality algorithm. Further, the software interface (205) may be used to generate/obtain the values (e.g., inputs, outputs, intermediary values) required/generated by the f8 confidentiality algorithm.

Those skilled in the art, having the benefit of this detailed description, will appreciate that the f8 confidentiality algorithm inputs: (i) a count parameter having a size of 32-bits and corresponding to a frame dependent input; (ii) a bearer parameter having a size of 5-bits and corresponding to a bearer identity; (iii) a direction parameter having a size of 1-bit and corresponding to a direction of transmission; (iv) a confidentiality key (CKey) having a size of 128-bits and for use in performing Kasumi operations; (v) a length parameter corresponding to the number of bits to be encrypted/decrypted; and (vi) an input bit stream ranging between 1-20,000 bits. Further, the f8 confidentiality algorithm outputs an output bit stream ranging between 1-20,000 bits.

In one or more embodiments of the invention, the system (200) of FIG. 2, may be used to implement the f9 integrity algorithm of 3GPP mobile communications. Specifically, the Kasumi engine (220) may be used to perform the one or more Kasumi operations and XOR operations required by the f9 integrity algorithm. Further, the software interface (205) may be used to generate/obtain the values (e.g., inputs, outputs, intermediary values) required/generated by the f9 integrity algorithm.

Those skilled in the art, having the benefit of this detailed description, will also appreciate that the f9 integrity algorithm inputs: (i) a counter parameter having a size of 32-bits and corresponding to a frame dependent input; (ii) a fresh parameter having a size of 32-bits and corresponding to a random number; (iii) a direction parameter having a size of 1-bit and corresponding to a direction of transmission; (iv) an integrity key (IKey) having a size of 128-bits and for use in performing Kasumi operations; (v) a length parameter corresponding to the number of bits to be transformed into a message authentication code (MAC); and (vi) a message to be transformed into the MAC. The message may be identical to the input bit stream discussed above in reference to the f8 confidentiality algorithm. Further, the f9 integrity algorithm outputs the MAC having a size of 32-bits.

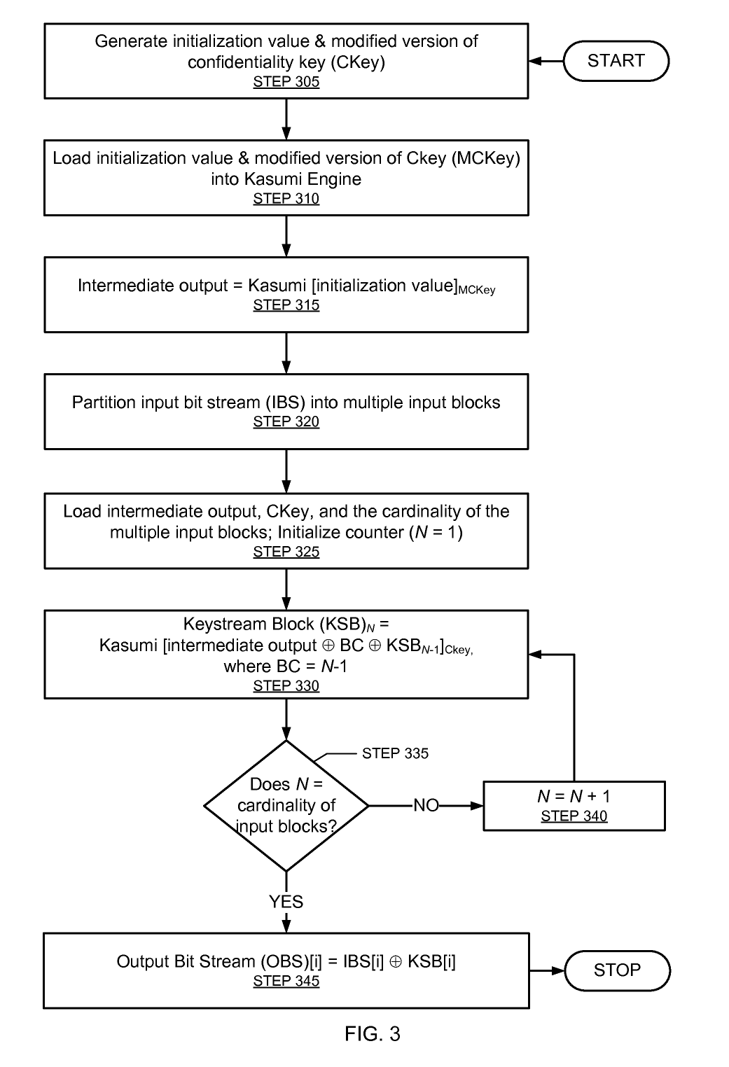

FIG. 3 shows a flowchart in accordance with one or more embodiments of the invention. The process shown in FIG. 3 may be used perform the f8 confidentiality algorithm of 3GPP mobile communications (e.g., using the Kasumi engine (220) and the software interface (205) discussed above in reference to FIG. 2). Those skilled in the art, having the benefit of this detailed description, will appreciate that the sequence of steps shown in FIG. 3 may differ among embodiments of the invention, and that one or more of the steps shown in FIG. 3 may be repeated or omitted.

Initially, an initialization value and a modified version of the CKey are generated (STEP 305). As discussed above, the f8 confidentiality algorithm comprises multiple inputs including a count parameter, a bearer parameter, and a direction parameter. In one or more embodiments of the invention, the initialization value is set to the concatenation of the count parameter, the bearer parameter, and the direction parameter. An additional 26 bits, each having a value of zero, may be added to the concatenated value to render the initialization value 64-bits in length. In other words, initialization value=count parameter||bearer parameter||direction parameter||0 . . . 0. In one or more embodiments of the invention, the initialization value is created by a software interface (i.e., software interface (205)) and then stored in a memory accessible to the software interface (i.e., memory (210)).

As also discussed above, the f8 confidentiality algorithm also inputs a 128-bit CKey. In one or more embodiments of the invention, a modified version of the CKey (MCKey) is generated by performing an XOR operation between the CKey and a key modifier. For example, the key modifier may have a value, in hexadecimal, of 0×55555555555555555555555555555555. In one or more embodiments of the invention, the MCKey is created by the software interface and then stored in the memory accessible by the software interface. The software interface may also store the CKey in the memory.

In STEP 310, the initialization variable and the MCKey are loaded from memory into a Kasumi engine (i.e., Kasumi engine (220)). In one or more embodiments of the invention, the Kasumi engine has direct access to the memory storing the initialization variable and the MCKey. Accordingly, the loading may be invoked by the Kasumi engine. Moreover, the initialization value and the MCKey may be loaded into registers (e.g., I/O registers (224)) within the Kasumi engine specifically designated to hold the initialization value and the MCKey.

In STEP 315, a Kasumi operation is executed on the initialization value, according to the MCKey, in order to generate an intermediate output. In other words, intermediate output=Kasumi [initialization value]_{MCKey}. In one or more embodiment of the invention, the Kasumi operation is performed by a hardware implemented Kasumi cipher (e.g., Kasumi cipher (222)) of the Kasumi engine. Further, the intermediate output may be stored within a register of the Kasumi engine. Further still, the intermediate output may be stored in the memory operatively connected to the Kasumi engine.

As discussed above, the f8 confidentiality algorithm includes, as input, an input bit stream (IBS). In STEP 320, the input bit stream is partitioned into input blocks with each input block having a length of 64-bits. In the event the length of the input bit stream is not an integer multiple of 64, the remaining bits of the input bit stream may be padded with zeros to create a final input block having a length of 64-bits. The total number of input blocks in the set of input blocks may be referred to as the cardinality of the set of input blocks. In one or more embodiments of the invention, the input bit stream is partitioned into input blocks and, if required, padded by the software interface. Further, the software interface may then store the cardinality of the set of input blocks in the memory accessible to the software.

In STEP 325, the intermediate output, the CKey, and the cardinality of the input blocks are loaded into the Kasumi engine. In one or more embodiments of the invention, the intermediate output, the CKey, and the cardinality of the input blocks are loaded into the Kasumi engine from the memory. Further, the input blocks themselves may be loaded into the Kasumi engine from the memory. As discussed above, the Kasumi engine may have registers specifically designated for each of the intermediate output, the CKey, and the cardinality of the input blocks. The Kasumi engine may also have registers specifically designated for the input blocks. In one or more embodiments of the invention, the loading of the intermediate output, the CKey, and/or the cardinality of the input blocks from the memory is invoked by the Kasumi engine.

In one or more embodiments of the invention, a counter (N) is initialized (i.e., N=1) as part of STEP 325. The counter N may be stored in a register of the Kasumi engine. In such embodiments, the counter N may be initialized by the Kasumi engine. Alternatively, the counter N may initialized by the software interface and stored in the memory accessible by the Kasumi engine. Those skilled in the art, having the benefit of this detailed description, will appreciate that the value N−1 may be referred to as a block counter (BC).

In STEP 330, a keystream block (KSB) is generated. Initially, multiple XOR operations are performed between the intermediate output, the BC (i.e., N−1), and the previously generated KSB (i.e., KSB_{N-1}). A Kasumi operation is performed on the result of the XOR operations, according to the CKey, in order to generate KSB_{N}. Thus, KSB_{N}=Kasumi [intermediate output ⊕BC⊕KSB_{N-1}]_{CKey}, where BC=N−1. Both KSB_{N} and KSB_{N-1} may be stored in registers of the Kasumi engine. In one or more embodiments of the invention, the Kasumi operation is performed by the hardware implemented Kasumi cipher of the Kasumi engine. Further, the XOR operations are performed by the Kasumi engine. In one or more embodiments of the invention, KSB₀ is defined as zero (i.e., KSB₀=0).

In STEP 335, it is determined whether the counter N equals the cardinality of the input blocks. When it is determined that the counter N equals the cardinality of the input blocks, the process proceeds to STEP 345. When it is determined that the counter N does not equal the cardinality of the input blocks (e.g., the counter N is less than the cardinality of the input blocks), the process proceeds to STEP 340. In one or more embodiments of the invention, STEP 335 is executed using the Kasumi engine to compare a register storing the counter N and a register storing the cardinality of the input blocks.

In STEP 340, the counter N is incremented. In one or more embodiments of the invention, the register storing the counter N is incremented by the Kasumi engine. After incrementing the counter N, the process proceeds back to STEP 330. Those skilled in the art, having the benefit of this detailed description, will appreciate that repeating STEP 330, STEP 335, and STEP 340 will result in the creation of multiple keystream blocks. In one or more embodiments of the invention, each of the multiple keystream blocks are stored in separate registers. Alternatively, the multiple keystream blocks may be concatenated (i.e., KSB=KSB₁||KSB₂||KSB₃|| . . . ).

In STEP 345, the output bit stream (OBS) is generated by performing XOR operations between the input blocks and the keystream blocks. Specifically, each bit of the output bit stream is generated by performing an XOR operation between the corresponding input stream bit and the corresponding bit in the concatenation of the keystream blocks. In other words, OBS[i]=IBS[i]⊕KSB[i]. In one or more embodiments of the invention, the output bit stream may be stored by the Kasumi engine in the memory.

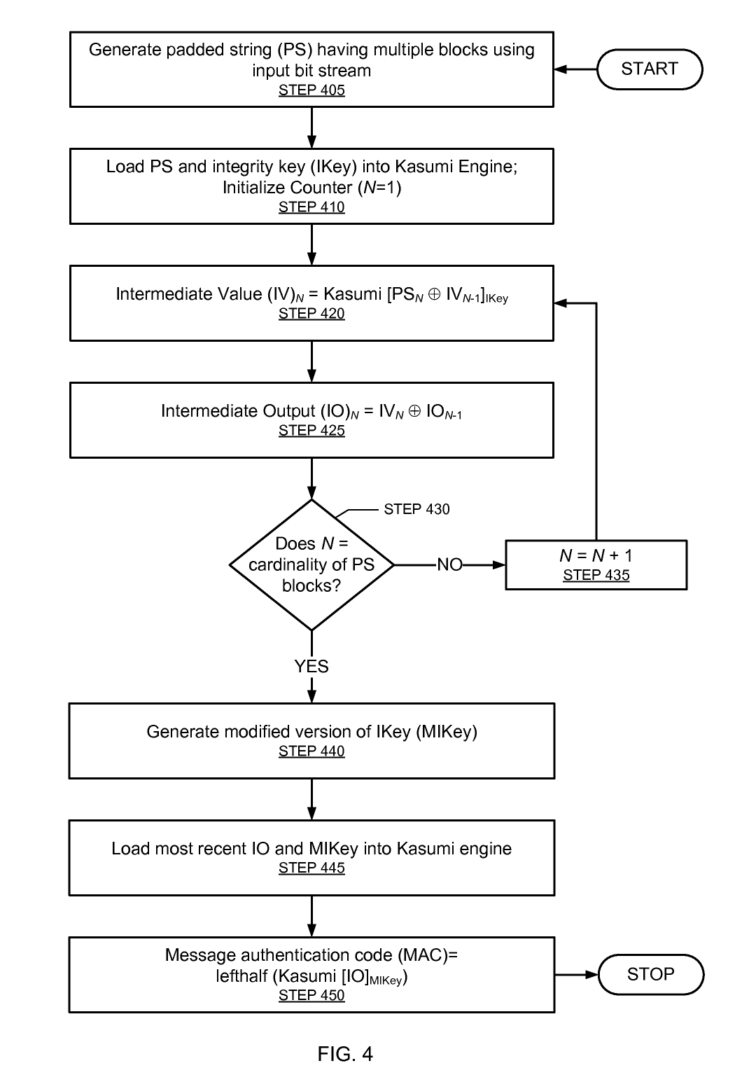

As discussed above, the process shown in FIG. 4 may be used to perform the f8 confidentiality algorithm of 3GPP mobile communications. Accordingly, if the input bit stream is encrypted, the output bit stream is the decrypted version of the input bit stream. Alternatively, if the input bit stream is plaintext, the output bit stream is the encrypted version of the input bit stream. Moreover, the process shown in FIG. 4 may be considered a software function (i.e., STEP 405) with two separate hardware functions. STEP 410, STEP 415 may correspond to a first hardware function, while STEP 420, STEP 425, STEP 430, STEP 435, STEP 440, and STEP 445 may correspond to a second hardware function.

FIG. 4 shows a flowchart in accordance with one or more embodiments of the invention. The process shown in FIG. 4 may be used perform the f9 integrity algorithm of 3GPP mobile communications (e.g., using the Kasumi engine (220) and the software interface (205) discussed above in reference to FIG. 2). Those skilled in the art, having the benefit of this detailed description, will appreciate that the sequence of steps shown in FIG. 4 may differ among embodiments of the invention, and that one or more of the steps shown in FIG. 4 may be repeated or omitted.

Initially, a padded string (PS) having multiple blocks is generated using the input bit stream (STEP 405). As discussed above, the f9 integrity algorithm comprises multiple inputs including a count parameter, a fresh parameter, a message (i.e., the input bit stream), and a direction parameter. In one or more embodiments of the invention, the PS is set to the concatenation of the count parameter, the fresh parameter, the message, and the direction parameter. A single “1” bit followed by one or more “0” bits may added to the concatenated value to render the total length of the PS an integer multiple of 64. In other words, PS=count parameter||fresh parameter||message||direction parameter||1||0 . . . 0.

In one or more embodiments of the invention, the PS is split into 64-bit blocks (i.e., PS=PS₁||PS₂||PS₃||. . . ). The total number of blocks forming the PS may be referred to as the cardinality of the PS. In one or more embodiments of the invention, the PS is created and split by a software interface (i.e., software interface (105)) and then stored in a memory accessible to the software interface (i.e., memory (210)). As also discussed above, the f9 integrity algorithm also inputs a 128-bit IKey. In one or more embodiments of the invention, the software interface generates and/or obtains the IKey and stores the IKey in the memory.

In STEP 410, the PS and the IKey are loaded from the memory into a Kasumi engine (i.e., Kasumi engine (220)). In one or more embodiments of the invention, the Kasumi engine has direct access to the memory storing the PS and the IKey. Accordingly, the loading is invoked by the Kasumi engine. Moreover, the initialization value and the IKey may be loaded into registers (e.g., I/O registers (224)) within the Kasumi engine specifically designated to hold the initialization value and the IKey.

In one or more embodiments of the invention, a counter (N) is initialized (i.e., N=1) as part of STEP 410. The counter may be stored in a register of the Kasumi engine. In such embodiments, the counter may be initialized by the Kasumi engine. Alternatively, the counter may be initialized by a software interface and stored in the memory accessible by the Kasumi engine.

In STEP 420, an intermediate value (IV) is generated. Initially, an XOR operation is performed between a previously generated IV (i.e., IV_{N-1}) and a block of the PS (i.e., PS_{N}). A Kasumi operation is then performed on the result of the XOR operation, according to the IKey, to generate IV_{N}. Thus, IV_{N}=Kasumi [IV_{N-1}⊕_{PSN]IKey}. Both IV_{N} and IV_{N-1} may be stored in registers of the Kasumi engine. In one or more embodiments of the invention, the Kasumi operation is performed by a hardware implemented Kasumi cipher (i.e., Kasumi cipher (222)) of the Kasumi engine. Further, the XOR operation is performed by the Kasumi engine. In one or more embodiments of the invention, IV₀ is defined as zero (i.e., IV₀=0).

In STEP 425, an intermediate output (IO) is generated. The IO is generated by performing an XOR operation between the current IV (i.e., IV_{N}) and a previously generated JO (i.e., IO_{N-1}). Thus, IO_{N}=IO_{N-1}⊕IV_{N}. Both IO_{N} and IO_{N-1} may be stored in registers of the Kasumi engine. The XOR operation between IO_{N-1} and IV_{N} may be performed by the Kasumi engine. In one or more embodiments of the invention, IO₀ is defined as zero (i.e., IO₀=0).

In STEP 430, it is determined whether the counter equals the cardinality of the PS blocks. When it is determined that the counter equals the cardinality of the PS blocks, the process proceeds to STEP 440. When it is determined that the counter does not equal the cardinality of the PS blocks (e.g., the counter is less than the cardinality of the PS blocks), the process proceeds to STEP 435. In one or more embodiments of the invention, STEP 430 is executed using the Kasumi engine to compare a register storing the counter and a register storing the cardinality of the PS blocks.

In STEP 435, the counter is incremented. In one or more embodiments of the invention, the register storing the counter is incremented by the Kasumi engine. After incrementing the counter, the process proceeds back to STEP 420. Those skilled in the art, having the benefit of this detailed description, will appreciate that repeating STEP 420, STEP 425, STEP 430, and STEP 435 may result in the creation of multiple IVs and IOs. In one or more embodiments of the invention, the most recent IO (i.e., IO_{|Cardinality of PS|}) may be stored in the memory.

As also discussed above, the f9 integrity algorithm inputs a 128-bit IKey. In STEP 440, a modified version of the IKey (MIKey) is generated. In one or more embodiments of the invention, the MIKey is generated by performing an XOR operation between the IKey and a key modifier having a value, in hexadecimal, of 0×AAAAAAAAAAAAAAAAAAAAAAAAAAAAAAAA. In one or more embodiments of the invention, the MIKey is created by the software interface and then stored in the memory.

In STEP 445, the most recent IO and the MIKey are loaded from memory into the Kasumi engine. Alternatively, the most recently IO may already exist in a register of the Kasumi engine and only the MIKey need be loaded from memory. In one or more embodiments of the invention, the Kasumi engine has direct access to the memory storing the MIKey and the most recent IO. Accordingly, the loading may be invoked by the Kasumi engine. Moreover, the most recent IO and the MIKey may be loaded into registers (e.g., I/O registers (224)) within the Kasumi engine specifically designated to hold the most recent IO and the MIKey.

In STEP 450, a message authentication code (MAC) is generated. Initially, a Kasumi operation is performed on the most recent IO according to the MIKey. The MAC is set to the left-most 32-bits (i.e., lefthalf) of the result from the Kasumi operation. In other words, MAC=lefthalf (Kasumi [IO_{|Cardinality of PS|}]_{MIKey})

As discussed above, the process shown in FIG. 4 may be used to perform the f9 confidentiality algorithm of 3GPP mobile communications. Moreover, the process shown in FIG. 4 may be considered multiple software functions (i.e., STEP 405, STEP 440) with two separate hardware functions. STEP 410, STEP 420, STEP 425, STEP 430, and STEP 435 may correspond to a first hardware function, while STEP 445, and STEP 450 may correspond to a second hardware function.

Those skilled in the art, having the benefit of this detailed description, will appreciate that by using a hardware implementation of a Kasumi cipher and a software interface to perform additional processing, a cost-effective implementation of the confidential f8 algorithm and the integrity f9 algorithm may be constructed. In other words, the proposed implementation may have speeds approaching that of a full hardware implementation of the confidential f8 algorithm and integrity f9 algorithm without the high costs associated with the full hardware implementation.

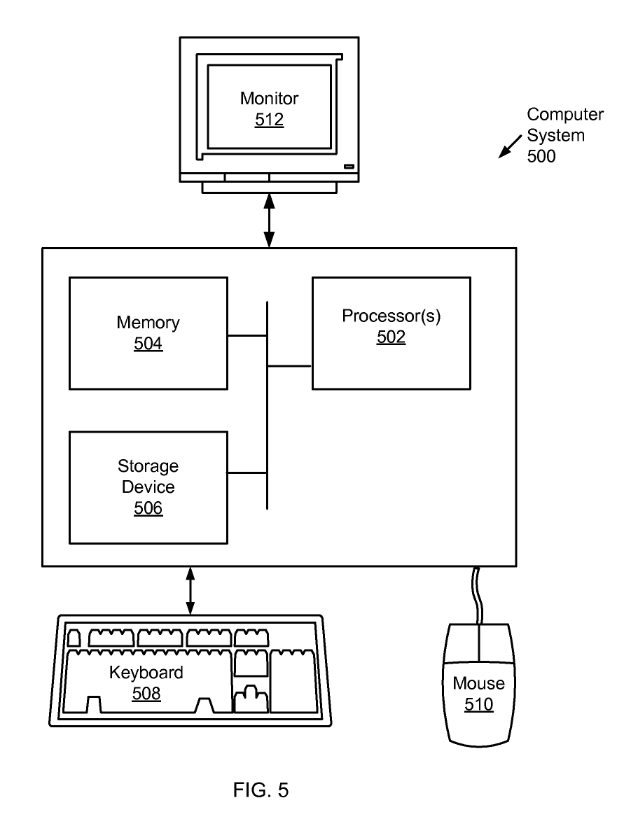

One or more embodiments of the invention may be implemented on virtually any type of computer regardless of the platform being used. For example, as shown in FIG. 5, a computer system (500) includes a processor (502), associated memory (504), a storage device (506), and numerous other elements and functionalities typical of today's computers (not shown). The computer system (500) may also include input means, such as a keyboard (508) and a mouse (510), and output means, such as a monitor (512). The computer system (500) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (500) may be located at a remote location and connected to the other elements over a network. Further, the invention may be implemented on a distributed system having a plurality of nodes, where each portion of the invention (e.g., software interface, memory, Kasumi engine) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a tangible computer readable storage medium such as a compact disc (CD), a diskette, a tape, a hard drive, or any other tangible computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of performing a confidentiality function for a plurality of input bits, comprising:
generating, using a software interface having access to a memory, an initialization value and a modified version of a confidentiality key (CKey);
loading, from the memory, the initialization value and the modified version of the CKey into a Kasumi engine having a hardware implementation of a Kasumi cipher;
executing, using the Kasumi cipher and based on the modified version of the CKey, an initial Kasumi operation on the initialization value to generate an intermediate output;
partitioning, using the software interface, the plurality of input bits into a plurality of input blocks and storing a cardinality of the plurality of input blocks in the memory;
loading, from the memory, the CKey and the cardinality into the Kasumi engine;
generating, using the Kasumi cipher and based on the cardinality and the CKey, a plurality of keystream blocks by executing a plurality of Kasumi operations on the intermediate output; and
generating a plurality of output bits by performing a plurality of exclusive-or (XOR) operations between the plurality of input blocks and the plurality of keystream blocks.

2. The method of claim 1, wherein the plurality of input bits are plain text and the plurality of output bits are encrypted.

3. The method of claim 1, further comprising:
storing the intermediate output in the memory after executing the initial Kasumi operation; and
loading, from the memory, the intermediate output into the Kasumi engine before generating the plurality of keystream blocks.

4. The method of claim 1, wherein generating the plurality of keystream blocks comprises:
executing, using the Kasumi cipher, a first Kasumi operation on the intermediate output to generate a first keystream block;
performing an XOR operation on the intermediate output with the first keystream block; and
executing, using the Kasumi cipher and after performing the XOR operation on the intermediate output, a second Kasumi operation on the intermediate output to generate a second keystream block,
wherein the plurality of Kasumi operations comprises the first Kasumi operation and the second Kasumi operation, and
wherein the plurality of keystream blocks comprises the first keystream block and the second keystream block.

5. The method of claim 1, wherein the modified version of the CKey is generated by performing an XOR operation between the CKey and a key modifier.

6. The method of claim 1, wherein each of the plurality of keystream blocks is 64 bits in size.

7. The method of claim 1, wherein the initialization value comprises a frame dependent input concatenated with a bearer identity and a direction of transmission.

8. A method of performing an integrity function for a plurality of input bits, comprising:
generating, using a software interface operatively connected to a memory, a padded string having a plurality of blocks by concatenating a random number and the plurality of input bits;
loading, from the memory, the padded string and an integrity key (IKey) into a Kasumi engine having a hardware implementation of a Kasumi cipher;
generating, using the Kasumi cipher and based on the IKey, a plurality of intermediate values by executing a plurality of initial Kasumi operations on the plurality of blocks;
performing a plurality of exclusive-or (XOR) operations between the plurality of intermediate values to generate an intermediate output;
generating, using the software interface, a modified version of the IKey;
loading, from the memory, the modified version of the IKey into the Kasumi engine; and
generating, using the Kasumi cipher and based on the modified version of the IKey, a message authentication code (MAC) by executing a Kasumi operation on the intermediate output.

9. The method of claim 8, wherein the Kasumi operation performed on the intermediate output generates a plurality of output bits, and wherein the MAC comprises a portion of the plurality of output bits.

10. The method of claim 8, further comprising:
storing the intermediate output in the memory after executing the plurality of initial Kasumi operations; and
loading, from the memory, the intermediate output into the Kasumi engine before generating the MAC.

11. The method of claim 8, wherein the modified version of the IKey is generated by performing an XOR operation between the IKey and a key modifier.

12. The method of claim 8, wherein generating the plurality of intermediate values comprises:
executing, using the Kasumi cipher, a first Kasumi operation on a first block of the plurality of blocks to generate a first intermediate value;
performing an XOR operation on a second block of the plurality of blocks with the first intermediate value; and
executing, using the Kasumi cipher and after performing the XOR operation on the second block, a second Kasumi operation on the second block to generate a second intermediate value,
wherein the plurality of initial Kasumi operations comprises the first Kasumi operation and the second Kasumi operation, and
wherein the plurality of intermediate values comprises the first intermediate value and the second intermediate value.

13. The method of claim 8, wherein the padded string is an integral multiple of 64 bits in size.

14. A system, comprising:
a memory;
a software interface, operatively connected to the memory, and configured to generate a modified version of a confidentially key (CKey), and a modified version of an integrity key (IKey); and
a Kasumi engine having a hardware implementation of a Kasumi cipher and configured to load the modified version of the CKey from the memory to perform a confidentiality function, and to load the modified version of the IKey from memory to perform an integrity function.

15. The system of claim 14, wherein the Kasumi engine performs the confidentiality function using a first operation, wherein the first operation includes executing, using the Kasumi cipher and based on the modified version of the CKey, a Kasumi operation to generate an intermediate output.

16. The system of claim 15, wherein the Kasumi engine further performs the confidentiality function using a second operation, wherein the second operation includes executing, using the Kasumi cipher and based on the CKey, a plurality of Kasumi operations on the intermediate output to generate a plurality of keystream blocks, and wherein the second operation further includes performing a plurality of exclusive-or (XOR) operations between the plurality of keystream blocks and a plurality of input blocks.

17. The system of claim 14, wherein the Kasumi engine performs the integrity function using a first operation, wherein the first operation includes executing, using the Kasumi cipher and based on the IKey, a plurality of Kasumi operations on a padded string to generate a plurality of intermediate values, and wherein the first operation further comprises performing a plurality of exclusive-or (XOR) operations on the plurality of intermediate values to generate an intermediate output.

18. The system of claim 17, wherein the Kasumi engine further performs the integrity function using a second operation, wherein the second operation includes executing, using the Kasumi cipher and based on the modified version of the IKey, a Kasumi operation on the intermediate output to generate a message authentication code (MAC).

19. The system of claim 14, wherein the software interface, the memory, and the Kasumi engine are part of a base station of a mobile cellular system.

20. The system of claim 14, wherein the software interface, the memory, and the Kasumi engine are part of a mobile telephone.
